(19) United States
(12) Patent Application Publication
(10) Pub. No.: US 2015/0200607 A1
(43) Pub. Date: Jul. 16, 2015

(54) POWER CONVERTER

(71) Applicant: TOSHIBA MITSUBISHI-ELECTRIC INDUSTRIAL SYSTEMS CORPORATION, Chuo-ku (JP)

(72) Inventors: Yosuke FUJII, Tokyo (JP); Eiichi Ikawa, Tokyo (JP)

(73) Assignee: TOSHIBA MITSUBISHI-ELECTRIC INDUSTRIAL SYSTEMS CORPORATION, Chuo-ku (JP)

(21) Appl. No.: 14/671,121

(22) Filed: Mar. 27, 2015

Related U.S. Application Data
(63) Continuation of application No. PCT/JP2012/074905, filed on Sep. 27, 2012.

(51) Int. Cl. H02M 7/537

(52) U.S. Cl. CPC H02M 7/537

(57) ABSTRACT

A power converter includes a power conversion circuit including a switching element, a device including an inductance and provided on an AC side of the power conversion circuit, an output-amount measuring module configured to measure an output amount of an output from the power conversion circuit, and a switching frequency determining module configured to determine a switching frequency at which the switching element is switched to reduce a loss including a loss due to the device, based on the output amount measured by the output-amount measuring module.

### CROSS REFERENCE TO RELATED APPLICATIONS

This application is a Continuation Application of PCT Application No. PCT/JP2012/074905, filed Sep. 27, 2012, the entire contents of which are incorporated herein by reference.

### BACKGROUND OF THE INVENTION

1. Field of the Invention

The present invention relates to a power converter.

2. Description of the Related Art

In general, various methods are known as ones for reducing a loss in a power conversion circuit including a semiconductor element.

For example, it is disclosed that an entire loss of a power converter in which a reactor is provided as a filter on an alternating current (AC) side can be reduced by applying a three-level inverter to the power converter (see, e.g., International Publication No. WO 2010/044164A1).

As losses of a semiconductor element, a steady loss and a switching loss are present. The switching loss increases as a switching frequency increases. On the other hand, the steady loss is hardly influenced by the switching frequency. Thus, as is known, the switching frequency is set to a low value to reduce an entire loss of a power conversion circuit.

However, in a power conversion circuit, normally, a device having an inductance such as a transformer or a reactor to perform filtering is provided on an AC side. In such a power converter, due to losses of those devices, the entire loss of the power converter is not necessarily reduced even by lowering the switching frequency.

### BRIEF SUMMARY OF THE INVENTION

An object of the present invention is to provide a power converter capable of effectively reducing an entire loss even if a device having an inductance is provided on an AC side.

A power converter according to an aspect of the invention comprises a power conversion circuit including a switching element; a device including an inductance and provided on an AC side of the power conversion circuit; an output-amount measuring module configured to measure an output amount of an output from the power conversion circuit; and a switching frequency determining module configured to determine a switching frequency at which the switching element is switched to reduce a loss including a loss due to the device, based on the output amount measured by the output-amount measuring module.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a configuration view showing a configuration of a power converter according to an embodiment of the present invention.

FIG. 2 is a configuration view showing a configuration of a switching frequency determining module according to the embodiment.

FIG. 3 is a graph chart indicating table data in a frequency determining table in the embodiment.

### DETAILED DESCRIPTION OF THE INVENTION

Embodiments of the present invention will be described with reference to the accompanying drawings.

### An Embodiment

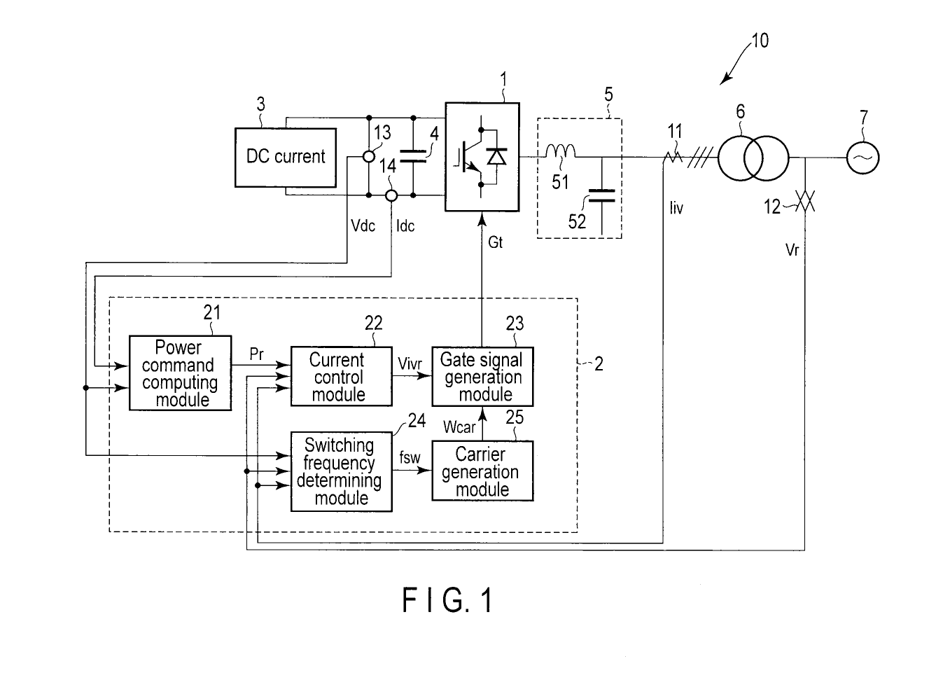

FIG. 1 is a configuration view showing a configuration of a power converter 10 according to an embodiment. It should be noted that with respect to each of the figures, portions identical to those in the other figures will be denoted by the same reference numerals as in the other figures, and after they are each explained once, their detailed explanations will be omitted, and only other portions will be explained.

The power converter 10 includes an inverter 1, a controller 2, a direct current (DC) power supply 3, a smoothing capacitor 4, an AC filter 5, an insulating transformer 6, an AC current detector 11, an AC voltage detector 12, a DC voltage detector 13, and a DC current detector 14. The power converter 10 is connected to an AC power system 7.

The DC power supply 3 supplies DC power to the inverter 1. Any device may be applied as the DC power supply 3 as long as it can supply DC power to the inverter 1. For example, the DC power supply 3 is a photovoltaic cell, a secondary cell, a fuel cell or the like.

The inverter 1 is an inverter to be subjected to a pulse width modulation (PWM) control. The inverter 1 converts the DC power supplied from the DC power supply 3 into AC power which synchronizes with the AC power system 7. The inverter 1 supplies the AC power to the AC power system 7 through the insulating transformer 6. A power conversion circuit (inverter circuit) of the inverter 1 includes a switching element.

The switching element is a semiconductor element. The switching element is, e.g., an insulated gate bipolar transistor (IGBT). The switching element is driven by a gate signal Gt output from the controller 2. Thereby, the inverter 1 performs power conversion.

The smoothing capacitor 4 is provided on a DC side of the inverter 1. The smoothing capacitor 4 smoothes DC power which is supplied from the DC power supply 3 to the inverter 1.

The AC filter 5 includes a reactor 51 and a capacitor 52. The AC filter 5 eliminates a harmonic output from the inverter 1.

The AC current detector 11 is a detector for measuring an output current Iiv of the inverter 1. The AC current detector 11 outputs the detected output current Iiv as a detection signal to the controller 2.

The AC voltage detector 12 is a detector for measuring a system voltage Vr of the AC power system 7. The AC voltage detector 12 outputs the detected system voltage Vr as a detection signal to the controller 2.

The DC voltage detector 13 is a detector for measuring a DC voltage Vdc which is applied to a DC side of the inverter 1. The DC voltage detector 13 outputs a detected DC voltage Vdc as a detection signal to the controller 2.

The DC current detector 14 is a detector for measuring a DC current Idc which is input to the DC side of the inverter 1. The DC current detector 14 outputs a detected DC current Idc as a detection signal to the controller 2.

The controller 2 includes a power command computing module 21, a current control module 22, a gate signal generation module 23, a switching frequency determining module 24 and a carrier generation module 25.

The power command computing module 21 computes a power command value Pr for use in controlling an output power of the power converter 10 on the basis of the DC voltage Vdc detected by the DC voltage detector 13 and the DC current Idc detected by the DC current detector 14. The power command computing module 21 outputs the computed power command value Pr to the current control module 22.

The current control module 22 computes a voltage command value Vivr for use in controlling an output voltage of the inverter 1 on the basis of the power command value Pr computed by the power command computing module 21, the output current Iiv detected by the AC current detector 11 and the system voltage Vr detected by the AC voltage detector 12. The current control module 22 outputs the computed voltage command value Vivr to the gate signal generation module 23.

The switching frequency determining module 24 determines a switching frequency fsw (i.e., a carrier frequency) on the basis of the output current Iiv detected by the AC current detector 11, the system voltage Vr detected by the AC voltage detector 12 and the DC voltage Vdc detected by the DC voltage detector 13. The switching frequency determining module 24 outputs the determined switching frequency fsw to the carrier generation module 25.

The carrier generation module 25 generates a carrier Wcar corresponding to the switching frequency fsw determined by the switching frequency determining module 24. The carrier generation module 25 outputs the generated carrier Wcar to the gate signal generation module 23.

The gate signal generation module 23 generates a gate signal Gt for switching a switching element included in the power conversion circuit in the inverter 1 on the basis of the voltage command value

Vivr computed by the current control module 22 and the carrier Wcar generated from the carrier generation module 25. The gate signal generation module 23 drives (switches) the switching element with the generated gate signal Gt at the switching frequency fsw. Thereby, the inverter 1 outputs an output in accordance with the voltage command value Vivr.

Next, a method for determining the switching frequency fsw with the switching frequency determining module 24 will be explained.

First of all, losses in the power converter 10 will be explained.

As the losses, a fixed loss, a proportional loss and a square loss are present. The fixed loss is a loss which does not directly influence a change of a flowing current. The proportional loss is a loss which increases in proportion to the flowing current. The square loss is a loss which increases in proportion to the square of the flowing current.

As fixed losses, an iron loss of a transformer (e.g., the insulating transformer 6), an iron loss of a reactor (e.g., the reactor 51), a cooling fan, control power supplies of various devices included in the power converter 10, etc. are present. The iron loss is a loss of electric energy which generates when an iron core magnetizes. As iron losses, a hysteresis loss, an eddy current loss, etc. are present.

The proportional loss is a loss proportional to the flowing current. The proportional loss is principally a switching loss of the switching element.

The square loss is a loss proportional to the square of the flowing current. As the square loss, a conduction loss of the switching element, a conduction loss of a busbar, a conduction loss of various elements such as a fuse, a copper loss of a transformer, a copper loss of a reactor, etc. are present. The copper loss is a loss of an electric energy due to a resistance of a conductor such as winding.

A fixed loss of a device having an inductance of an AC filter circuit increases in proportion to a harmonic component of the output current Iiv of the inverter 1. The harmonic component of the output current Iiv is reduced as the switching frequency fsw is raised. Therefore, the iron loss of the transformer and the iron loss of the reactor decrease when the switching frequency fsw is raised. This is because when the switching frequency fsw is raised, the harmonic component decreases. Furthermore, the fixed losses of those devices increase as the DC voltage Vdc of the inverter 1 increases.

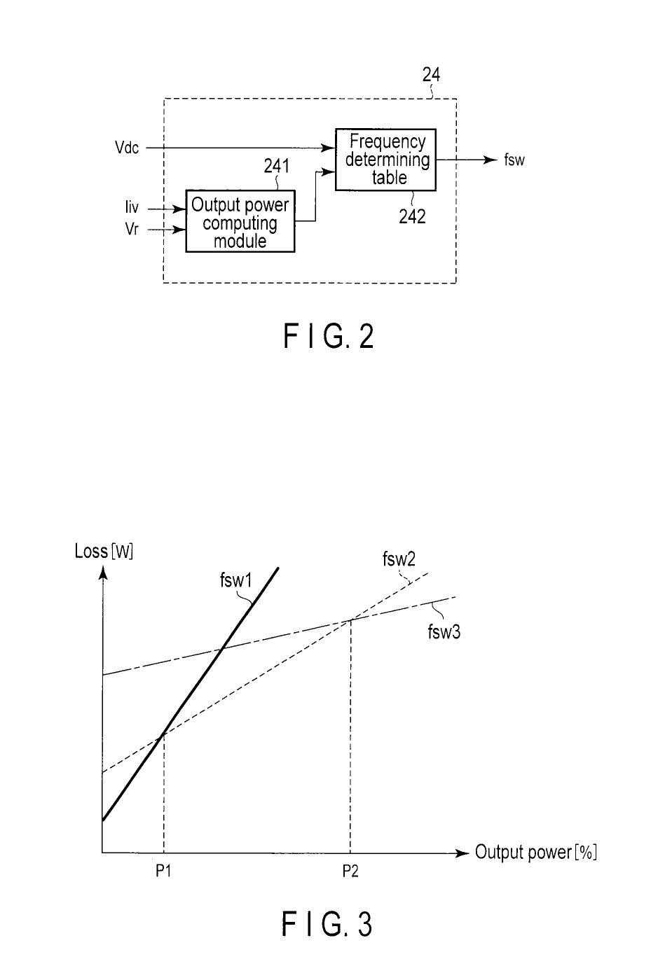

FIG. 2 is a configuration view of the switching frequency determining module 24 according to the embodiment.

The switching frequency determining module 24 includes an output power computing module 241 and a frequency determining table 242.

The output power computing module 241 computes an output power of the power converter 10 on the basis of the output current Iiv measured by the AC current detector 11 and the system voltage Vr measured by the AC voltage detector 12. The output power computing module 241 outputs the computed output power to the frequency determining table 242.

The frequency determining table 242 determines the switching frequency fsw on the basis of the DC voltage Vdc measured by the DC voltage detector 13 and the output power of the power converter 10 computed by the output power computing module 241.

FIG. 3 is a chart graph indicating table data at a certain DC voltage Vdc in the frequency determining table 242 according to the embodiment. FIG. 3 shows a relationship between a loss and output power of each of switching frequencies fsw1 to fsw3.

In the following explanation, suppose the frequency determining table 242 selects one of three switching frequencies fsw1, fsw2 and fsw3. Also, suppose a first switching frequency fsw1, a second switching frequency fsw2 and a third switching frequency fsw3, are in ascending order.

In the frequency determining table 242, table data is set in advance. The table data is determined in consideration of the above various losses of the power converter 10. The frequency determining table 242 corrects or changes table data shown in FIG. 3 if the DC voltage Vdc changes. Thereby, the frequency determining table 242 prepares table data corresponding to the DC voltage Vdc.

The frequency determining table 242 determines the switching frequency fsw with the table data shown in FIG. 3 on the basis of the output power of the power converter 10. If the output power is smaller than P1 [%], the frequency determining table 242 selects the first switching frequency fsw1. If the output power is equal to or greater than P1 [%] and smaller than P2 [%], the frequency determining table 242 selects the second switching frequency fsw2. If the output power is greater than P2 [%], the frequency determining table 242 selects the third switching frequency fsw3.

According to the embodiment, the switching frequency fsw is determined based on the output power of the power converter 10, as a result of which it is possible to provide a power converter capable of effectively reducing an entire loss even if a device having an inductance is provided on an AC side.

It should be noted that if only a reactor having a small inductance is provided as a device having an inductance on the AC side of the inverter 1, a loss due to the reactor is small with respect to a switching loss of the switching element. In such a case, it is possible to reduce an entire loss of the power converter 10 simply by lowering the switching frequency fsw. On the other hand, if a device having a great inductance is provided on the AC side of the inverter 1, a loss due to the device is not negligible with respect to the switching loss of the switching element. In the power converter 10 provided with such a device, the entire loss is not necessarily lowered simply by lowering the switching frequency fsw. Such a case occurs frequently in the case where the output of the inverter 1 is not 100%.

Even in such a case as described above, in the power converter 10 according to the embodiment, an optimal switching frequency fsw is determined to lower the loss with respect to the output power, thus enabling the loss to be effectively lowered.

It should be noted that in the embodiment, the switching frequency fsw is determined based on the output power of the power converter 10 and the DC voltage Vdc of the inverter 1. The way is not limited to such a way. Instead of the output power of the power converter 10, the output current of the power converter 10 may be applied. That is, it is possible to achieve the same structure as in the embodiment, using the output current, by handing the system voltage Vr as a constant. Similarly, it is possible to achieve the same structure as in the embodiment without using the DC voltage Vdc, by handing the DC voltage Vdc as a constant.

In the embodiment, a structure is made to select one of the three switching frequencies fsw1, fsw2 and fsw3 in order to reduce the loss. The structure of the embodiment is not limited to such a structure. That is, any number of switching frequencies to be selected may be set as long as the number thereof is two or more. Furthermore, instead of selecting the switching frequency fsw, it may be set to compute an optimal switching frequency fsw to lower the loss, using the output power, the output current or the DC voltage Vdc.

With respect to the embodiment, as to the structure for determining the voltage command value Vivr for the output of the inverter 1, a simple structure is explained by way of example; however, a command value for the output of the inverter 1 may be determined in any manner. For example, if the DC power supply 3 is a photovoltaic cell, the command value for the output of the inverter 1 may be determined based on a DC power command value or a DC voltage command value which is determined by a maximum power point tracking (MPPT) control.

With respect to the embodiment, the above explanation is given with respect to a structure in which the AC filter 5 and the insulating transformer 6 are provided as devices having inductances on the AC side of the inverter 1. However, the structure is not limited to such a structure as described above. For example, an interconnection reactor may be provided instead of the insulating transformer 6, or the embodiment may be applied without providing such devices. Furthermore, the insulating transformer 6 or the interconnection reactor may be combined with the reactor 51 of the AC filter 5 into a single element.

It is to be noted that the present invention is not restricted to the foregoing embodiments, and constituent elements can be modified and changed into shapes without departing from the scope of the invention at an embodying stage. Additionally, various inventions can be formed by appropriately combining a plurality of constituent elements disclosed in the foregoing embodiments. For example, several constituent elements may be eliminated from all constituent elements disclosed in the embodiments. Furthermore, constituent elements in the different embodiments may be appropriately combined.

What is claimed is:

1. A power converter comprising:
a power conversion circuit including a switching element;
a device including an inductance and provided on an AC side of the power conversion circuit;
an output-amount measuring module configured to measure an output amount of an output from the power conversion circuit; and
a switching frequency determining module configured to determine a switching frequency at which the switching element is switched to reduce a loss including a loss due to the device, based on the output amount measured by the output-amount measuring module.

2. The power converter of claim 1, wherein the switching frequency determining module determines to increase the switching frequency.

3. The power converter of claim 1, wherein the switching frequency determining module selects one of a plurality of switching frequencies determined in advance.

4. The power converter of claim 2, wherein the switching frequency determining module selects one of a plurality of switching frequencies determined in advance.

5. The power converter of claim 1, further comprising a DC voltage measuring module which measures a DC voltage of the power conversion circuit, and wherein the switching frequency determining module determines the switching frequency based on the DC voltage measured by the DC voltage measuring module.

6. The power converter of claim 2, further comprising a DC voltage measuring module which measures a DC voltage of the power conversion circuit, and
wherein the switching frequency determining module determines the switching frequency based on the DC voltage measured by the DC voltage measuring module.

7. The power converter of claim 3, further comprising a DC voltage measuring module which measures a DC voltage of the power conversion circuit, and
wherein the switching frequency determining module determines the switching frequency based on the DC voltage measured by the DC voltage measuring module.

8. The power converter of claim 4, further comprising a DC voltage measuring module which measures a DC voltage of the power conversion circuit, and
wherein the switching frequency determining module determines the switching frequency based on the DC voltage measured by the DC voltage measuring module.

9. A control method for a power conversion circuit in which a device including an inductance is provided on an AC side, and which including a switching element, the control method comprising:
measuring an output amount of an output from the power conversion circuit; and
determining based on the measured output amount, a switching frequency at which the switching element is switched to reduce a loss including a loss due to the device.

10. The control method of claim 9, wherein the determining the switching frequency includes determining to increase the switching frequency.

11. The control method of claim 9, wherein the determining the switching frequency is selecting one of a plurality of switching frequencies determined in advance.

12. The control method of claim 10, wherein the determining the switching frequency is selecting one of a plurality of switching frequencies determined in advance.

13. The control method of claim 9, further comprising measuring a DC voltage of the power conversion circuit, and
wherein the switching frequency is determined based on the measured DC voltage.

14. The control method of claim 10, further comprising measuring a DC voltage of the power conversion circuit, and
wherein the switching frequency is determined based on the measured DC voltage.

15. The control method of claim 11, further comprising measuring a DC voltage of the power conversion circuit, and
wherein the switching frequency is determined based on the measured DC voltage.

16. The control method of claim 12, further comprising measuring a DC voltage of the power conversion circuit, and
wherein the switching frequency is determined based on the measured DC voltage.
